(19) United States
(12) Patent Application Publication
(10) Pub. No.: US 2020/0143698 A1
(43) Pub. Date: May 7, 2020

(54) METHOD FOR ADJUSTING TRAINING OF A SPECIFIC USER AND SERVER USING THE SAME

(71) Applicant: TEKVILLE.COM INC., Seoul (KR)

(72) Inventors: Ki Hyun Park, Seoul (KR); Ho Cheon Wey, Gyeonggi-do (KR); Dai Il Heo, Seoul (KR)

(21) Appl. No.: 16/202,412

(22) Filed: Nov. 28, 2018

(30) Foreign Application Priority Data
Nov. 6, 2018 (KR) 10-2018-0135502

(51) Int. Cl. G09B 7/00

(52) U.S. Cl. CPC G09B 7/00; G09B 19/0069

(57) ABSTRACT

A method for adjusting a training of a specific user is provided. The method includes steps of: (a) a server acquiring identification information of the specific user from a user terminal, and (b) the server performing or supporting another device to perform, by referring to the identification information, (I) a first process of allowing the specific user to train basic knowledge data and basic motion data on a specific subject by providing a pre-training content to the user terminal; (II) a second process of allowing the specific user to train practice knowledge data or practice motion data on the specific subject by providing a practice training content to the user terminal; and (III) a third process of allowing the specific user to train application knowledge data and application motion data required to solve scenario-based problems on the specific subject by providing a scenario-based training content to the user terminal.

### CROSS REFERENCE TO RELATED APPLICATION

This application claims priority to and incorporates herein by reference all disclosure in Korean patent application no. 10-2018-0135502 filed Nov. 6, 2018.

### FIELD OF DISCLOSURE

The present disclosure relates to a method for adjusting a training of a specific user; and more particularly, to the method for adjusting the training of the specific user, including steps of: (a) acquiring identification information of the specific user from a user terminal, and (b) performing or supporting another device to perform, by referring to the identification information, at least one of (I) a first process of allowing the specific user to train at least part of basic knowledge data and basic motion data on a specific subject by providing at least one pre-training content to the user terminal; (II) a second process of allowing the specific user to train at least part of one or more practice knowledge data or practice motion data on the specific subject by providing at least one practice training content to the user terminal; and (III) a third process of allowing the specific user to train at least part of one or more application knowledge data and application motion data required to solve one or more scenario-based problems on the specific subject by providing at least one scenario-based training content to the user terminal, and a server using the same.

### BACKGROUND OF THE DISCLOSURE

A virtual-reality technology is provided to allow users to experience virtual environments similar to the real world by using computers. The technology is used in various fields such as games, healthcare, culture, medical care, and education.

However, a conventional educational-training system provides training contents to the users unilaterally. That is, the conventional educational-training system has failed to achieve interactions with the users or servers, and it has been hard for the system to provide an adjustable training progress or proper feedbacks according to training state of the users.

Further, there has been conventionally provided fixed form of evaluation results such as simple values on training achievement, and success or failure, etc. For this reason, it has been difficult to judge whether the evaluation results are actually reliable or not.

Thus, a new educational-training system based on the virtual-reality technology is proposed in this specification. The new system provides the adjustable training progress by analyzing the respective training state of the users.

### SUMMARY OF THE DISCLOSURE

It is an object of the present disclosure to solve all the aforementioned problems.

It is another object of the present disclosure to provide methods for supporting customized educational-training by analyzing individual feedbacks and training state of multiple users.

It is still another object of the present disclosure to provide methods for adjustable evaluations, which are different from conventional evaluations, by analyzing the training state of the multiple users.

In accordance with one aspect of the present disclosure, there is provided a method for adjusting a training of a specific user, including steps of: (a) a server acquiring identification information of the specific user from a user terminal, and (b) the server performing or supporting another device to perform, by referring to the identification information, at least one of (I) a first process of allowing the specific user to train at least part of basic knowledge data and basic motion data on a specific subject by providing at least one pre-training content to the user terminal; (II) a second process of allowing the specific user to train at least part of one or more practice knowledge data or practice motion data on the specific subject by providing at least one practice training content to the user terminal; and (III) a third process of allowing the specific user to train at least part of one or more application knowledge data and application motion data required to solve one or more scenario-based problems on the specific subject by providing at least one scenario-based training content to the user terminal.

As one example, at the first process, the server performs or supports another device to perform processes of: (I-1) creating the pre-training content by referring to at least part of (i) (1_1)-st data including first incorrect motion data, as the basic motion data of multiple users, generated in response to multiple first contents on the specific subject; and (ii) (1_2)-nd data including second incorrect motion data, as the basic motion data of the specific user, generated in response to the multiple first contents on the specific subject; and (I-2) providing the created pre-training content to the user terminal.

As one example, the server performs or supports another device to perform processes of: (i) creating the pre-training content by applying weights determined by the specific user or the server respectively to the (1_1)-st data and the (1_2)-nd data, and (ii) providing the created pre-training content to the user terminal.

As one example, at the first process, the server performs or supports another device to perform processes of: (I-1) extracting a specific basic motion data, corresponding to multiple first contents on the specific subject, from (i) (2_1)-st data including third incorrect motion data, as the basic motion data of multiple users, generated in response to multiple second contents on another subject; and (ii) (2_2)-nd data including forth incorrect motion data, as the basic motion data of the specific user, generated in response to the multiple second contents on said subject; (I-2) creating the pre-training content by referring to at least part of the extracted specific basic motion data, and (I-3) providing the created pre-training content to the user terminal.

As one example, the server performs or supports another device to perform processes of: (i) creating the pre-training content by applying weights determined by the specific user or the server respectively to the (2_1)-st data and the (2_2)-nd data, and (ii) providing the created pre-training content to the user terminal.

As one example, at the second process, the server performs or supports another device to perform processes of: (II-1) setting at least part of a minimum allotted time and the number of repetitions for k-th practice motion data respectively corresponding to multiple k-th practice training contents, (II-2) if the specific user attains the minimum allotted time corresponding to the k-th practice motion data while training a specific k-th practice training content, (i) in case one or more times are left for the specific user to reach the number of repetitions for specific k-th practice motion data, allowing the specific user to train a specific k-th practice motion by performing at least part of (i-1) decreasing the minimum allotted time assigned to the specific k-th practice training content for the specific user; and (i-2) decreasing the number of repetitions assigned to the specific k-th practice training content for the specific user; and (ii) in case the specific user reaches the number of repetitions, allowing the specific user to complete the specific k-th practice motion, and (II-3) if the specific user fails to attain the minimum allotted time corresponding to the k-th practice motion data while training the specific k-th practice training content, allowing the specific user to train the specific k-th practice motion by performing at least part of (i) increasing the minimum allotted time assigned to the specific k-th practice training content for the specific user; and (ii) increasing the number of repetitions assigned to the specific k-th practice training content for the specific user.

As one example, the server performs or supports another device to perform processes of: (I) providing (i) one or more diagnosis evaluations to estimate the specific user's achievement in the pre-training content; (ii) one or more formative evaluations, containing one or more progress evaluations, practice evaluations and test evaluations, to estimate the specific user's achievement in the practice training content; and (iii) one or more summative evaluations to estimate the specific user's achievement in the scenario-based training content; to the user terminal, (II) adjusting (i) allotted scores for respective actions included in the practice evaluations by referring to respective practice evaluation data acquired from multiple user terminals respectively corresponding to multiple users; and (ii) allotted scores for respective items included in the test evaluations by referring to respective test evaluation data acquired from the multiple user terminals respectively corresponding to multiple users, and (III) adjusting a ratio of the allotted scores for the respective progress evaluations, practice evaluations and test evaluations included in the respective formative evaluations by referring to an adjusted total score of the practice evaluations and to an adjusted total score of the formative evaluations, wherein the adjusted total score of the practice evaluations is acquired by adjusting the allotted scores for the respective actions included in the practice evaluations by referring to the respective practice evaluation data acquired from the multiple user terminals respectively corresponding to the multiple users, and wherein the adjusted total score of the test evaluations is acquired by adjusting the allotted scores for the respective items included in the test evaluations by referring to the respective test evaluation data acquired from the multiple user terminals respectively corresponding to multiple users.

As one example, on condition that at least part of progress evaluations, practice evaluations, and test evaluations is provided in order to estimate the specific user's achievement respectively in the pre-training content, the practice training content, and the scenario-based training content, to the user terminal, wherein a total score of the respective practice evaluations is determined by referring to individual scores for respective multiple actions included in the respective practice evaluations, and wherein initial allotted scores and modifiable ranges of the individual allotted scores respectively corresponding to the multiple actions are predetermined, the server performs or supports another device to perform processes of: (I) acquiring incorrect action data respectively from multiple user terminals of respective multiple users created in response to the multiple practice evaluations respectively corresponding to the pre-training content, the practice training content, and the scenario-based training content, in order to adjust the individual allotted scores for the respective multiple actions included in the respective practice evaluations; (II) if the number of a specific incorrect action of the multiple users is same as or larger than the predetermined threshold, an allotted score for the specific incorrect action increases; and (III) if the number of the specific incorrect action of the multiple users is less than the predetermined threshold, the allotted score for the specific action decreases.

As one example, on condition that at least part of progress evaluations, practice evaluations, and test evaluations is provided in order to estimate the specific user's achievement respectively in the pre-training content, the practice training content, and the scenario-based training content, to the user terminal, wherein a total score of the respective test evaluations is determined by referring to individual scores for respective multiple items included in the respective test evaluations, and wherein initial allotted scores and modifiable ranges of individual allotted scores respectively corresponding to the multiple items are predetermined, the server performs or supports another device to perform processes of: (I) acquiring incorrect response rate data from respective multiple user terminals of respective multiple users created in response to the multiple test evaluations respectively corresponding to the pre-training content, the practice training content, and the scenario-based training content, in order to adjust the individual allotted scores for the respective multiple items included in the respective test evaluations; (II) if an incorrect response rate of a specific item from the multiple users is same as or larger than the predetermined threshold, an allotted score for the specific item increases; and (III) if the incorrect response rate of the specific item from the multiple users is less than the predetermined threshold, the allotted score for the specific item decreases.

As one example, the server provides one or more avatars to guide the specific user, wherein, by referring to input data on the specific user acquired from at least part of interfaces and sensors interworking with the user terminal, the avatar performs at least part of processes of (I) providing the respective contents to the specific user, (II) showing at least part of exemplary actions and responses for the respective contents to the specific user, (III) providing information on incorrect actions and incorrect responses from the specific user or other users, and (IV) managing training progress of the specific user and providing messages of encouragement.

In accordance with another aspect of the present disclosure, there is provided a server for adjusting a training of a specific user, including: at least one memory that stores instructions; and at least one processor configured to execute the instructions to: perform or support another device to perform, by referring to identification information of the specific user from a user terminal, at least one of (I) a first process of allowing the specific user to train at least part of basic knowledge data and basic motion data on a specific subject by providing at least one pre-training content to the user terminal; (II) a second process of allowing the specific user to train at least part of one or more practice knowledge data or practice motion data on the specific subject by providing at least one practice training content to the user terminal; and (III) a third process of allowing the specific user to train at least part of one or more application knowledge data and application motion data required to solve one or more scenario-based problems on the specific subject by providing at least one scenario-based training content to the user terminal.

As one example, at the first process, the processor performs or supports another device to perform processes of: (I-1) creating the pre-training content by referring to at least part of (i) (1_1)-st data including incorrect motion data, as the basic motion data of multiple users, generated in response to multiple first contents on the specific subject; and (ii) (1_2)-nd data including incorrect motion data, as the basic motion data of the specific user, generated in response to multiple first contents on the specific subject; and (I-2) providing the created pre-training content to the user terminal.

As one example, the processor performs or supports another device to perform processes of: (i) creating the pre-training content by applying weights determined by the specific user or the processor respectively to the (1_1)-st data and the (1_2)-nd data, and (ii) providing the created pre-training content to the user terminal.

As one example, at the first process, the processor performs or supports another device to perform processes of: (I-1) extracting a specific basic motion data, corresponding to multiple first contents on the specific subject, from (i) (2_1)-st data including incorrect motion data, as the basic motion data of multiple users, generated in response to multiple second contents on another subject; and (ii) (2_2)-nd data including incorrect motion data, as the basic motion data of the specific user, generated in response to the multiple second contents on said subject; (I-2) creating the pre-training content by referring to at least part of the extracted specific basic motion data, and (I-3) providing the created pre-training content to the user terminal.

As one example, the processor performs or supports another device to perform processes of: (i) creating the pre-training content by applying weights determined by the specific user or the processor respectively to the (2_1)-st data and the (2_2)-nd data, and (ii) providing the created pre-training content to the user terminal.

As one example, at the second process, the processor performs or supports another device to perform processes of: (II-1) setting at least part of a minimum allotted time and the number of repetitions for k-th practice motion data respectively corresponding to multiple k-th practice training contents, (II-2) if the specific user attains the minimum allotted time corresponding to the k-th practice motion data while training a specific k-th practice training content, (i) in case one or more times are left for the specific user to reach the number of repetitions for specific k-th practice motion data, allowing the specific user to train a specific k-th practice motion by performing at least part of (i-1) decreasing the minimum allotted time assigned to the specific k-th practice training content for the specific user; and (i-2) decreasing the number of repetitions assigned to the specific k-th practice training content for the specific user; and (ii) in case the specific user reaches the number of repetitions, allowing the specific user to complete the specific k-th practice motion, and (II-3) if the specific user fails to attain the minimum allotted time corresponding to the k-th practice motion data while training the specific k-th practice training content, allowing the specific user to train the specific k-th practice motion by performing at least part of (i) increasing the minimum allotted time assigned to the specific k-th practice training content for the specific user; and (ii) increasing the number of repetitions assigned to the specific k-th practice training content for the specific user.

As one example, the processor performs or supports another device to perform processes of: (I) providing (i) one or more diagnosis evaluations to estimate the specific user's achievement in the pre-training content; (ii) one or more formative evaluations, containing one or more progress evaluations, practice evaluations and test evaluations, to estimate the specific user's achievement in the practice training content; and (iii) one or more summative evaluations to estimate the specific user's achievement in the scenario-based training content; to the user terminal, (II) adjusting (i) allotted scores for respective actions included in the practice evaluations by referring to respective practice evaluation data acquired from multiple user terminals respectively corresponding to multiple users; and (ii) those for respective items included in the test evaluations by referring to respective test evaluation data acquired from the multiple user terminals respectively corresponding to multiple users, and (III) adjusting a ratio of the allotted scores for the respective progress evaluations, practice evaluations and test evaluations included in the respective formative evaluations by referring to an adjusted total score of the practice evaluations and to an adjusted total score of the formative evaluations, wherein the adjusted total score of the practice evaluations are acquired by adjusting the allotted scores for the respective actions included in the practice evaluations by referring to the respective practice evaluation data acquired from the multiple user terminals respectively corresponding to the multiple users, and wherein the adjusted total score of the formative evaluations is acquired by adjusting the allotted scores for the respective items included in the test evaluations by referring to the respective test evaluation data acquired from the multiple user terminals respectively corresponding to multiple users.

As one example, on condition that at least part of progress evaluations, practice evaluations, and test evaluations is provided in order to estimate the specific user's achievement respectively in the pre-training content, the practice training content, and the scenario-based training content, to the user terminal, wherein a total score of the respective practice evaluations is determined by referring to individual scores for respective multiple actions included in the respective practice evaluations, and wherein initial allotted scores and modifiable ranges of the individual allotted scores respectively corresponding to the multiple actions are predetermined, the processor performs or supports another device to perform processes of: (I) acquiring incorrect action data respectively from multiple user terminals of respective multiple users created in response to the multiple practice evaluations respectively corresponding to the pre-training content, the practice training content, and the scenario-based training content, in order to adjust the individual allotted scores for the respective multiple actions included in the respective practice evaluations; (II) if the number of a specific incorrect action of the multiple users is same as or larger than the predetermined threshold, an allotted score for the specific incorrect action increases; and (III) if the number of the specific incorrect action of the multiple users is less than the predetermined threshold, the allotted score for the specific action decreases.

As one example, on condition that at least part of progress evaluations, practice evaluations, and test evaluations is provided in order to estimate the specific user's achievement respectively in the pre-training content, the practice training content, and the scenario-based training content, to the user terminal, wherein a total score of the respective test evaluations is determined by referring to individual scores for respective multiple items included in the respective test evaluations, and wherein initial allotted scores and modifiable ranges of individual allotted scores respectively corresponding to the multiple items are predetermined, the processor performs or supports another device to perform processes of: (I) acquiring incorrect response rate data from respective multiple user terminals of respective multiple users created in response to the multiple test evaluations respectively corresponding to the pre-training content, the practice training content, and the scenario-based training content, in order to adjust the individual allotted scores for the respective multiple items included in the respective test evaluations; (II) if an incorrect response rate of a specific item from the multiple users is same as or larger than the predetermined threshold, an allotted score for the specific item increases; and (III) if the incorrect response rate of the specific item from the multiple users is less than the predetermined threshold, the allotted score for the specific item decreases.

As one example, the processor provides one or more avatars to guide the specific user, wherein, by referring to input data on the specific user acquired from at least part of interfaces and sensors interworking with the user terminal, the avatar performs at least part of processes of (I) providing the respective contents to the specific user, (II) showing at least part of exemplary actions and responses for the respective contents to the specific user, (III) providing information on incorrect actions and incorrect responses from the specific user or other users, and (IV) managing training progress of the specific user and providing messages of encouragement.

In addition, recordable media that are readable by a computer for storing a computer program to execute the method of the present disclosure is further provided.

### BRIEF DESCRIPTION OF THE DRAWINGS

The drawings attached below are to explain example embodiments of the present disclosure and are only part of preferred embodiments of the present disclosure. Other drawings may be obtained based on the drawings herein without inventive work for those skilled in the art. The above and other objects and features of the present disclosure will become apparent from the following description of preferred embodiments given in conjunction with the accompanying drawings, in which:

FIG. 1 is a system diagram illustrating an entire system including a server, which adjusts training of users, based on a virtual-reality based educational-training system in accordance with one example embodiment of the present disclosure.

FIG. 2 is a diagram illustrating details on the server, which adjusts the training of the users, based on the virtual-reality based educational-training system in accordance with one example embodiment of the present disclosure.

FIG. 3A is a flow diagram illustrating a first process of the virtual-reality based educational-training system provided by the server in accordance with one example embodiment of the present disclosure.

FIG. 3B is a flow diagram illustrating a second process of the virtual-reality based educational-training system provided by the server in accordance with one example embodiment of the present disclosure.

FIG. 3C is a flow diagram illustrating a third process of the virtual-reality based educational-training system provided by the server in accordance with one example embodiment of the present disclosure.

FIG. 4 is an exemplary diagram illustrating a progress of adjusting allotted scores for practice evaluations in accordance with one example embodiment of the present disclosure.

### DETAILED DESCRIPTION OF THE PREFERRED EMBODIMENTS

Detailed explanation on the present disclosure to be made below refer to attached drawings and diagrams illustrated as specific embodiment examples under which the present disclosure may be implemented to make clear of purposes, technical solutions, and advantages of the present disclosure. These embodiments are described in sufficient detail to enable those skilled in the art to practice the disclosure.

Besides, in the detailed description and claims of the present disclosure, a term “include” and its variations are not intended to exclude other technical features, additions, components or steps. Other objects, benefits, and features of the present disclosure will be revealed to one skilled in the art, partially from the specification and partially from the implementation of the present disclosure. The following examples and drawings will be provided as examples but they are not intended to limit the present disclosure.

Moreover, the present disclosure covers all possible combinations of example embodiments indicated in this specification. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

To allow those skilled in the art to the present disclosure to be carried out easily, the example embodiments of the present disclosure by referring to attached diagrams will be explained in detail as shown below.

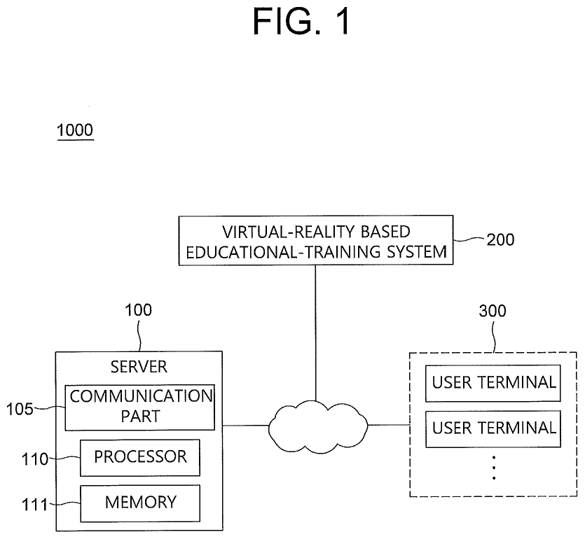

FIG. 1 is illustrating an entire system 1000 including a server, which adjusts training of users, based on a virtual-reality based educational-training system in accordance with one example embodiment of the present disclosure.

Referring to FIG. 1, the entire system 1000 may include the server 100, the virtual-reality based educational-training system 200, and user terminals 300, etc.

For reference, in FIG. 1 of the present disclosure, the server 100 and the user terminals 300 may interwork with the virtual-reality based educational-training system 200, but it does not mean that FIG. 1 of the present disclosure excludes cases of (i) the server 100 including the virtual-reality based educational-training system 200 and (ii) the user terminals 300 including the virtual-reality based educational-training system 200.

First, the server 100 may interwork with the virtual-reality based educational-training system 200, which will be delineated later, and multiple user terminals 300. The virtual-reality based educational-training system 200 may allow the users to train knowledge data and motion data on a specific subject and may provide evaluations on training achievement and certificates thereof.

Further, the server 100 may include a communication part 105 and a processor 110. The communication part 105 may perform exchanging information while communicating with the virtual-reality based educational-training system 200 and the user terminals 300.

Herein, the communication part 105 may be implemented by using various communication technology such as WIFI, WCDMA (Wideband CDMA), HSDPA (High Speed Downlink Packet Access), HSUPA (High Speed Uplink Packet Access), HSPA (High Speed Packet Access), Mobile WiMAX, WiBro, LTE (Long Term Evolution), bluetooth, IrDA (Infrared Data Association), NFC (Near Field Communication), Zigbee, and Wireless Lan, etc. In case of providing services through the Internet, the communication part 105 may comply with TCP/IP which is a protocol for transmitting information through the Internet.

In addition, the server 100 may further include a memory 111 capable of storing computer readable instructions for performing following processes. As one example, the processor 110, the memory 111, a medium, etc. may be integrated with an integrated processor.

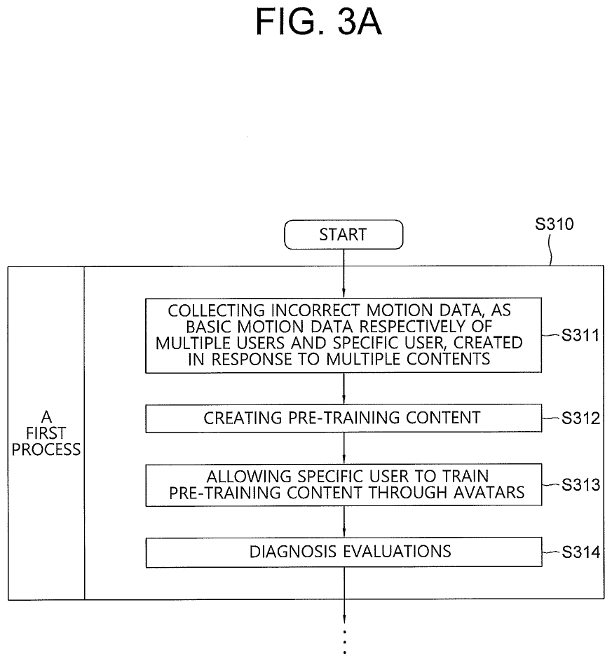

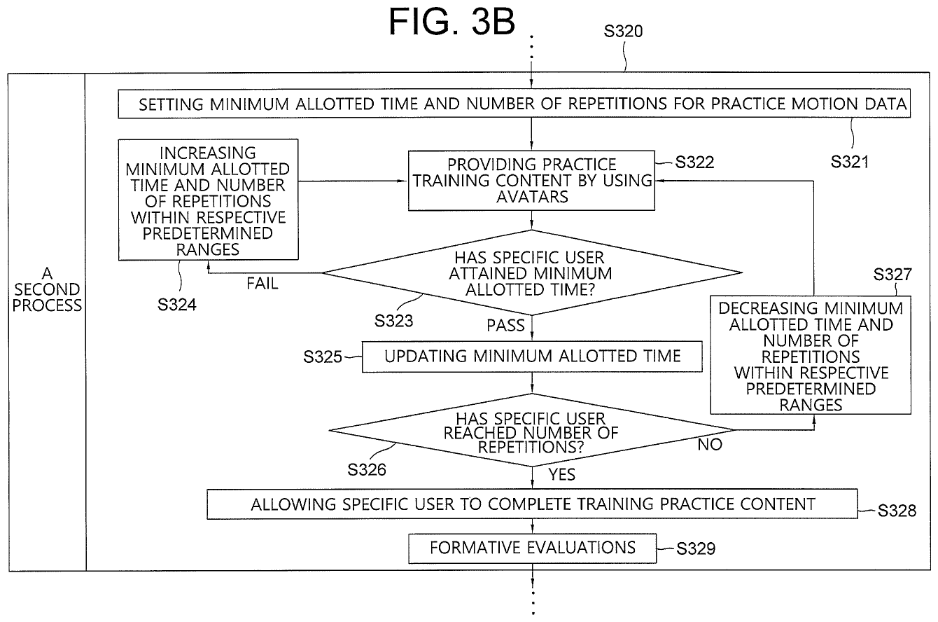

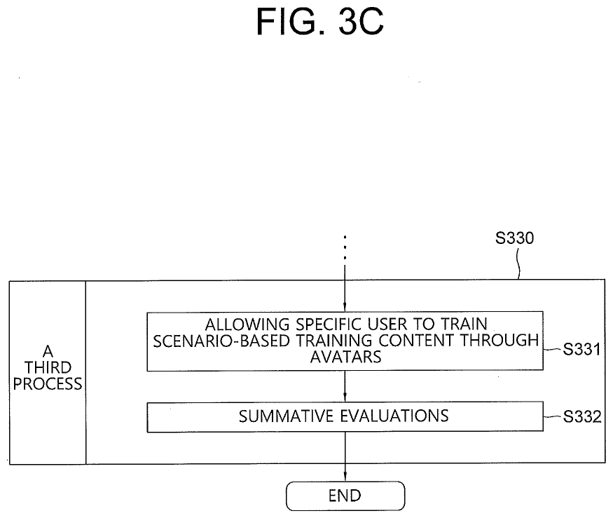

Meanwhile, the processor 110 may interwork with the virtual-reality based educational-training system 200 and the user terminals 300 through the communication part 105. Detailed explanation on the processor 110 will be made below by referring to FIG. 3A, FIG. 3B, and FIG. 3C.

Next, the virtual-reality based educational-training system 200 may provide at least one virtual-reality content to the users, thereby allowing them to train knowledge data and motion data on the specific subject. The virtual-reality content may include at least one of 3D modeling data, an audio, a video, etc., on the specific subject.

For example, the specific subject may include ‘repair of certain products’, ‘operating vehicles’, and ‘medical care’, etc., but it is not limited thereto.

Next, the user terminals 300 are digital apparatuses capable of accessing the server 100 and of communicating therewith. The user terminals 300 may include at least one of a desktop computer, a laptop computer, a workstation, a PDA, a web pad, and a mobile phone, etc. Any digital apparatuses containing a memory and a microprocessor can be selected as the user terminals 300 in accordance with the present disclosure.

Also, the user terminals 300 may interwork with at least one of input devices and output devices that enable the users to train the virtual-reality contents. The input devices may include at least one of a controller, a data glove, a camera, a motion activated camera, an infrared sensor, and an acceleration sensor, etc., but it is not limited thereto. Further, the output devices may include an HMD (Head Mounted Display), and smart glasses, etc., but it is not limited thereto.

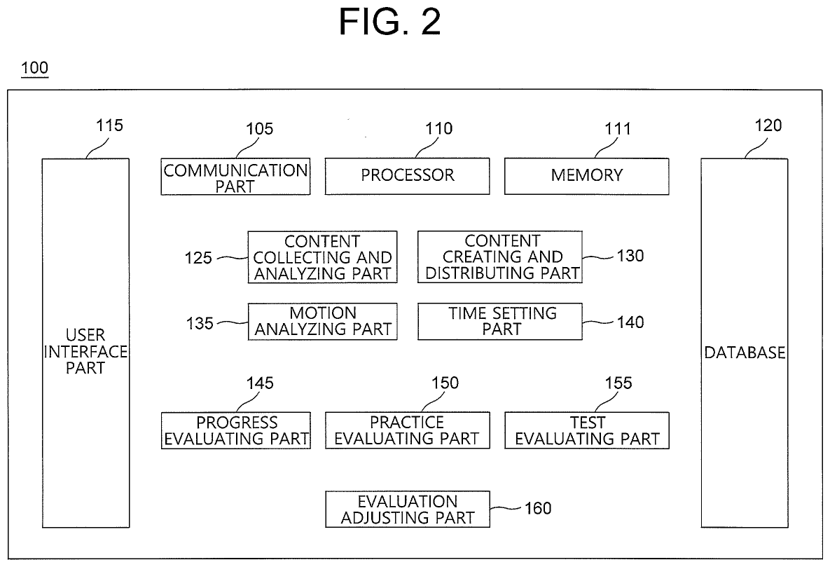

Detailed explanation on respective functions of components of the server 100 and virtual-reality based educational-training progress provided by the server 100 in accordance with one example embodiment of the present disclosure will be made below by referring to FIG. 2 and FIG. 3A, FIG. 3B, and FIG. 3C.

FIG. 2 is a diagram illustrating details on the server, which adjusts the training of the users, based on the virtual-reality based educational-training system 200 in accordance with one example embodiment of the present disclosure. FIG. 3A, FIG. 3B, and FIG. 3C are flow diagrams respectively illustrating a first process, a second process, and a third process of the virtual-reality based educational-training progress provided by the server 100 in accordance with one example embodiment of the present disclosure.

Referring to FIG. 2, besides the communication part 105 and the processor 110, the server 100 may further include at least part of a user interface part 115, a database 120, a content collecting and analyzing part 125, a content creating and distributing part 130, a motion analyzing part 135, a time setting part 140, a progress evaluating part 145, a practice evaluating part 150, a test evaluating part 155, and an evaluation adjusting part 160.

In FIG. 2 of the present disclosure, the database 120 is included in the server 100, but it does not mean that FIG. 2 of the present disclosure excludes a case that the database 120 is located external to the server 100, interworking therewith. Further, it does not mean that FIG. 2 of the present disclosure excludes a case that the user interface part 115, the database 120, the content collecting and analyzing part 125, the content creating and distributing part 130, the motion analyzing part 135, the time setting part 140, the progress evaluating part 145, the practice evaluating part 150, the test evaluating part 155, and the evaluation adjusting part 160 are implemented by the processor 110.

First, according to determination of the processor 110 or metadata of the contents included in the virtual-reality based educational-training system 200, the user interface part 115 may provide at least one user interface which allows the users to interwork with the server 100 to the user terminals 300.

The user interface may interwork with at least one of the input devices and the output devices.

Next, the database 120 may include various contents required to support the training and to evaluate the user's achievement. Further, the database 120 may also include identification information, training history, and evaluation history of the users, etc.

Detailed explanation on the respective functions of other components and the virtual-reality educational-training progress will be made below by referring to FIG. 3A, FIG. 3B, and FIG. 3C.

Referring to FIG. 3A, FIG. 3B, and FIG. 3C, the processor 110 of the server 100 may acquire the identification information of a specific user from the user terminal 300 through the communication part 105. Then, by referring to the identification information, the processor 110 of the server 100 may perform or support another device to perform at least one of (I) the first process of allowing the specific user to train at least part of basic knowledge data and basic motion data on the specific subject by providing at least one pre-training content to the user terminal 300 at a step of S310; (II) the second process of allowing the specific user to train at least part of one or more practice knowledge data or practice motion data on the specific subject by providing at least one practice training content to the user terminal 300 at a step of S320; and (III) the third process of allowing the specific user to train at least part of one or more application knowledge data and application motion data required to solve one or more scenario-based problems on the specific subject by providing at least one scenario-based training content to the user terminal 300 at a step of S330.

Herein, the processor 110 may manage information on multiple levels, such as a beginner level, an intermediate level, and an advanced level and may perform the first process, the second process, and the third process according to the respective levels.

For example, referring to the FIG. 3A, FIG. 3B, and FIG. 3C, the processor 110 may provide a separate UI capable of allowing users of the intermediate level and those of the advanced level to skip the pre-training content and to train the practice training content and the scenario-based training content. Otherwise, the processor 110 may selectively provide educational-training content to the users of the intermediate level and the users of the advanced level according to a predetermined condition, by performing only the second process for the practice training content and the third process for the scenario-based training content.

Meanwhile, if the specific subject is automobile maintenance, examples for the pre-training content, the practice training content, and the scenario-based training content may be as below.

First, the pre-training content for the automobile maintenance may include various contents supporting the users to train the basic knowledge data regarding respective names, functions, and figurations, etc., of components and the basic motion data regarding revolution, separation, zoom-in, and zoom-out, etc.

Next, the practice training content for the automobile maintenance may include various contents supporting the users to train the practice knowledge data and the practice motion data. For example, in a category of ‘e-compressor for air-conditioner’, there may be provided various contents such as ‘stopping engine after operating air-conditioner’, ‘shutting off high voltage’, ‘refrigerant recovery’, and ‘removing undercover of engine room’, etc.

Next, the scenario-based training content for the automobile maintenance may include various contents supporting the users to train the application knowledge data and the application motion data for handling situations occurred during repairing automobiles. For example, if a specific situation occurred while repairing a specific component, there may be provided a content based on a scenario including (i) finding a cause of the specific situation, (ii) solving a problem of the specific situation with proper procedure, and (iii) cleaning up repair tools.

Meanwhile, by using the content collecting and analyzing part 125, the processor 110 may collect and analyze said contents acquired from the database 120 of the server 100 and/or from at least one external server of one or more educational institutions related to said subject.

Further, by using the content creating and distributing part 130, the processor 110 may create and distribute adjusted contents by referring to at least part of the collected and analyzed contents and input data from the users.

Next, the processor 110, at the first process, may collect at least part of (i) (1_1)-st data including first incorrect motion data, as the basic motion data of multiple users, created in response to multiple first contents on the specific subject and (ii) (1_2)-nd data including second incorrect motion data, as the basic motion data of the specific user, created in response to the multiple first contents on the specific subject, through the motion analyzing part 135 at a step of S311.

Then, the processor 110 may create the pre-training content by referring to at least part of the (1_1)-st data and the (1_2)-nd data, through the content creating and distributing part 130 at a step of S312. Thereafter, the processor 110 may provide the created pre-training content to the user terminals 300, thereby allowing the users to train it at a step of S313.

That is, the processor 110 may create the pre-training content including the first incorrect motion data of the multiple users and the second incorrect motion data of the specific user, by collecting and analyzing (i) the (1_1)-st data including the first incorrect motion data, as the basic motion data of the multiple users, created in response to the multiple first contents on the specific subject, which is same as what the specific user choose; and (ii) the (1_2)-nd data including the second incorrect motion data, as the basic motion data of the specific user, created in response to the multiple first contents on the specific subject. This may contribute to an educational effect of a next step, i.e., a step of using the practice training content.

Also, the processor 110 may create the pre-training content by applying weights determined by the specific user or the processor 110 respectively to the (1_1)-st data and the (1_2)-nd data, and may provide the created pre-training content to the user terminal 300.

For example, if the weight for the (1_1)-st data determined by the specific user or the processor 110 is 0.4 and the weight for the (1_2)-nd data determined by the specific user or the processor 110 is 0.6, and if a ratio of essential contents of the pre-training content is set as 50%, the (1_1)-st data may be allotted as 20% of the pre-training content and the (1_2)-nd data may be allotted as 30% thereof.

Also, if there are overlapped parts between the (1_1)-st data and the (1_2)-nd data, the processor 110 may determine the weights according to its predetermined set-up by using at least one algorithm.

Meanwhile, the processor 110 may extract a specific basic motion data, corresponding to the multiple first contents on the specific subject, from (i) (2_1)-st data including third incorrect motion data, as the basic motion data of the multiple users, generated in response to multiple second contents on another subject and (ii) (2_2)-nd data including forth incorrect motion data, as the basic motion data of the specific user, generated in response to the multiple second contents on said subject, through the motion analyzing part 135.

Then, the processor 110 may create the pre-training content by referring to at least part of the extracted specific basic motion data through the content creating and distributing part 130. Thereafter, the processor 110 may provide the created pre-training content to the user terminals 300, thereby allowing the users to train it.

For example, if the specific subject chosen by the specific user is ‘automobile maintenance for hybrid compact car manufactured by A company’, the processor 110 may collect the third incorrect motion data of the multiple users and the forth incorrect motion data of the specific user, respectively generated in response to the multiple second contents on another subject, such as ‘automobile maintenance for hybrid car manufactured by B company’ and ‘automobile maintenance for compact car manufactured by A company’, in the database 120. Then, the processor 110 may create the pre-training content by referring to at least part of the third and the forth incorrect motion data.

Also, the processor 110 may create the pre-training content by applying weights determined by the specific user or the processor 110 respectively to the (2_1)-st data and the (2_2)-nd data, and may provide the created pre-training content to the user terminal 300.

Also, referring to the (1_1)st data, the (1_2)-nd data, the (2_1)-st data, and the (2_2)-nd data, the processor 110 may create the pre-training content by applying weights determined by the specific user or the processor 110 respectively to the respective data.

Referring to FIG. 3B, the processor 110, at the second process, may set at least part of a minimum allotted time and the number of repetitions for k-th practice motion data respectively corresponding to multiple k-th practice training contents through the time setting part 140 at a step of S321.

Herein, if the specific user attains the minimum allotted time corresponding to the k-th practice motion data while training a specific k-th practice training content at a step of S323, in case one or more times are left for the specific user to reach the number of repetitions for specific k-th practice motion data at a step of S326, the processor 110 may allow the specific user to train a specific k-th practice motion by performing at least part of (i) decreasing the minimum allotted time assigned to the specific k-th practice training content for the specific user and (ii) decreasing the number of repetitions assigned to the specific k-th practice training content for the specific user at a step of S327, through the time setting part 140 at a step of S322.

For example, if the minimum allotted time corresponding to the k-th practice motion data is set as 20 seconds and the number of repetitions for the specific k-th practice motion data is set as 5 times, and if the specific user attain 20 seconds in a first try, the processor 110 may decrease the minimum allotted time for the specific k-th practice motion as 19 seconds and then may allow the specific user to train the specific k-th practice motion data, or may decrease the remaining number of repetitions for the specific k-th practice motion from 5 to 4. As another example, the processor 110 may decrease the remaining number of repetitions for the specific k-th practice motion from 5 to 3 or from 5 to 2, considering successful achievement of the specific user in the first try. Further, in case the specific user reaches the number of repetitions at the step of S326, the processor 110 may allow the specific user to complete the specific k-th practice motion and to train a next practice training content at a step of S328.

Herein, a range of the minimum allotted time and that of the number of repetitions may be predetermined by a trainer or the server 100.

On the other hand, if the specific user fails to attain the minimum allotted time corresponding to the k-th practice motion data while training the specific k-th practice training content at the step of S323, the processor 110 may allow the specific user to train the specific k-th practice motion by performing at least part of (i) increasing the minimum allotted time assigned to the specific k-th practice training content for the specific user and (ii) increasing the number of repetitions assigned to the specific k-th practice training content for the specific user at a step of S324, through the time setting part 140 at the step of S322.

That is, if it takes 25 seconds for the specific user to train the specific k-th practice motion, the processor 110 may judge that the specific user is not skilled enough yet regarding the training of the specific k-th practice motion and may increase the minimum allotted time from 20 seconds to 23 seconds or the number of repetitions from 4 times to 6 times in order to allow the specific user to become proficient regarding the specific k-th practice motion.

Through the progress explained above, the processor 110 in accordance with the present disclosure may provide an adjustable training program by analyzing the training state of the multiple users.

Next, referring to FIG. 3C, the processor 110, at the third process, may allow the specific user to train at least part of said one or more application knowledge data and application motion data required to solve the said one or more scenario-based problems on the specific subject by providing the said at least one scenario-based training content to the user terminal 300 at a step of S331.

Meanwhile, the processor 110 may provide (i) one or more diagnosis evaluations to estimate the specific user's achievement in the pre-training content at a step of S314), (ii) one or more formative evaluations to estimate the specific user's achievement in the practice training content at a step of S329 and (iii) one or more summative evaluations to estimate the specific user's achievement in the scenario-based training content at a step of S332 to the user terminal 300.

Further, the formative evaluations may contain one or more progress evaluations, practice evaluations and test evaluations. The progress evaluations, the practice evaluations and the test evaluations may be conducted respectively by the progress evaluating part 145, the practice evaluating part 150, and the test evaluating part 155.

Herein, the processor 110 may adjust (i) allotted scores for respective actions included in the practice evaluations by referring to respective practice evaluation data acquired from the multiple user terminals 300 respectively corresponding to the multiple users and (ii) those for respective items included in the test evaluations by referring to respective test evaluation data acquired from the multiple user terminals 300 respectively corresponding to the multiple users, through the evaluation adjusting part 160.

Herein, if an adjusted total score of the practice evaluations is acquired by adjusting the allotted scores for the respective actions included in the practice evaluations, and if an adjusted total score of the test evaluations is acquired by adjusting the allotted scores for the respective items included in the test evaluations, the processor 110 may adjust a ratio of the allotted scores for the respective progress evaluations, practice evaluations and test evaluations included in the respective formative evaluations through the evaluation adjusting part 160, by referring to the adjusted total score of the practice evaluations and to the adjusted total score of the test evaluations.

For example, if the allotted scores for the respective progress evaluations, practice evaluations and test evaluations are determined respectively as 30, 40 and 30, the adjusted total score of the practice evaluations may be 50, which is acquired by adjusting the allotted scores for the respective actions included in the practice evaluations by referring to the respective practice evaluation data respectively corresponding to the multiple users, and the adjusted total score of the test evaluations may be 40, which is acquired by adjusting the allotted scores for the respective items included in the test evaluations by referring to the respective test evaluation data acquired from the multiple user terminals 300 respectively corresponding to the multiple users.

In this case, (i) the allotted scores respectively for the practice evaluations and the test evaluations may be determined respectively as 38.9 and 31.1 by converting a sum of the adjusted total scores respectively for the practice evaluations and the test evaluations from 90 to predetermined 70, or (ii) the allotted scores respectively for the progress evaluations, the practice evaluations, and the test evaluations may be determined respectively as 25, 41.7 and 33.3 by converting a sum of the adjusted total scores respectively for the progress evaluations, the practice evaluations and the test evaluations from 120 to predetermined 100.

Meanwhile, the processor 110 may also provide at least part of the progress evaluations, the practice evaluations, and the test evaluations in order to estimate the specific user's achievement respectively in the pre-training content, the practice training content, and the scenario-based training content, to the user terminals 300.

That is, the diagnosis evaluations, the formative evaluations, and the summative evaluations may respectively include at least part of the progress evaluations, the practice evaluations, and the test evaluations.

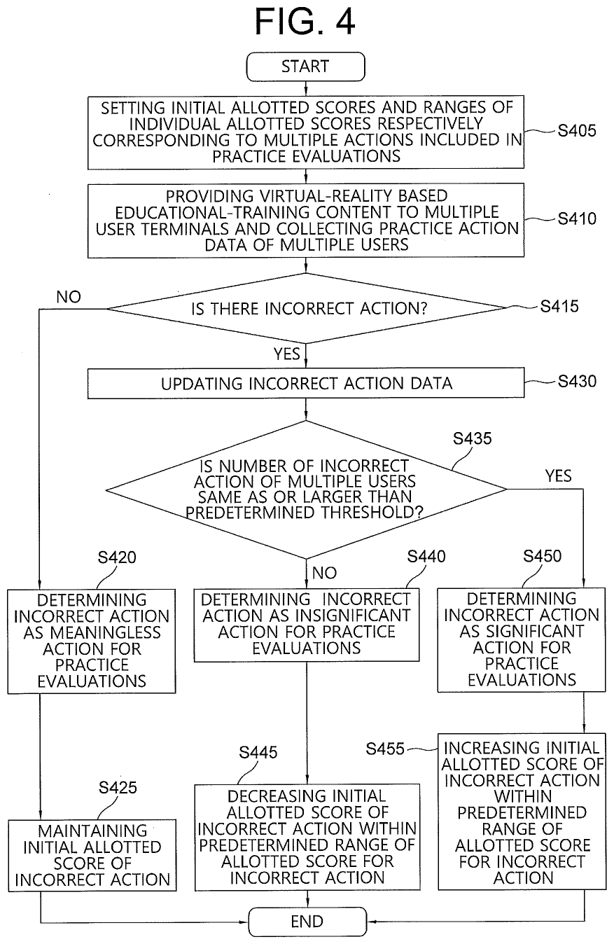

Next, detailed explanation on the processes for adjusting the allotted scores for the practice evaluations will be made below by referring to FIG. 4.

FIG. 4 is an exemplary diagram illustrating a progress of adjusting the allotted scores for the practice evaluations in accordance with one example embodiment of the present disclosure.

Specifically, the total score of the respective practice evaluations may be determined by referring to individual scores for respective multiple actions included in the respective practice evaluations. Herein, initial allotted scores and ranges of the individual allotted scores respectively corresponding to the multiple actions may be predetermined by the server 100 or the trainer at a step of S405.

Next, the processor 110 may acquire incorrect action data respectively from the multiple user terminals 300 of the respective multiple users created in response to the multiple practice evaluations respectively corresponding to the pre-training content, the practice training content, and the scenario-based training content, in order to adjust the individual allotted scores for the respective multiple actions included in the respective practice evaluations, through the motion analyzing part 135 at processes of S410, S415, and S430.

For example, a content of ‘disassembly procedure for shutting off high voltage’ in the category of ‘e-compressor for air-conditioner’ may include practice action data such as ‘disassembling supplementary battery cover’, ‘disassembling negative terminal of supplementary battery’ and ‘removing safety plug cover’. Further, the ‘disassembling negative terminal of supplementary battery’ may include the incorrect action data such as ‘incorrect sequence’ and ‘incorrect tool’.

That is, the incorrect action data may include various incorrect actions. For example, the specific user may disassemble a positive terminal instead of the negative terminal, or may choose B tool instead of A tool, and the processor 110 may determine those actions as the incorrect actions.

Herein, if an action of the specific user is not included in the incorrect action data, the processor 110 may determine the action as a meaningless action for the evaluations at a step of S420, and may maintain an allotted score for the action without any change therein through the evaluation adjusting part 160 at a step of S425.

Also, if the number of a specific incorrect action of the multiple users is same as or larger than the predetermined threshold at a step of S435, the processor 110 may determine the specific incorrect action as a significant action in the practice evaluations at a step of S450 and may increase an allotted score for the specific incorrect action through the evaluation adjusting part 160 at a step of S455.

On the other hand, if the number of the specific incorrect action of the multiple users is less than the predetermined threshold at the step of S435, the processor 110 may determine the specific incorrect action as an insignificant action in the practice evaluations at a step of S440 and may decrease the allotted score for the specific action at a step of S445 through the evaluation adjusting part 160.

Meanwhile, detailed explanation on the processes to adjust the allotted scores for the test evaluations will be made below.

First, the processor 110 may acquire incorrect response rate data from the respective multiple user terminals 300 of the respective multiple users created in response to the multiple test evaluations respectively corresponding to the pre-training content, the practice training content, and the scenario-based training content, in order to adjust the individual allotted scores for respective multiple items included in the respective test evaluations.

Herein, a total score of the respective test evaluations may be determined by referring to the individual scores for the respective multiple items included in the respective test evaluations. Herein, initial allotted scores and ranges of the individual allotted scores respectively corresponding to the multiple items may be predetermined.

That is, when the users take tests through the user terminals 300, results of the tests may be transferred to the server 100. Then, the processor 110 may grade the results and may collect correct and incorrect response data.

Herein, if an incorrect response rate of a specific item from the multiple users is same as or larger than the predetermined threshold, the processor 110 may determine the specific item as significant item in the test evaluations and may increase an allotted score of the specific item through the evaluation adjusting part 160.

On the other hand, if the incorrect response rate of the specific item from the multiple users is less than the predetermined threshold, the processor 110 may determine the specific item as insignificant item in the test evaluations and may decrease the allotted score for the specific item.

Further, if the incorrect response rate of the specific item from the multiple users is within a predetermined range, the processor 110 may determine the specific item as moderate item in the test evaluations and may maintain the allotted score for the specific item.

Through the progress explained above, the server 100 in accordance with the present disclosure may provide a more adjustable evaluation system by analyzing the training state of the multiple users, compared to a conventional evaluation system.

Meanwhile, the processor 110 may provide one or more avatars to guide the specific user.

The avatars may guide the specific user during the whole training by referring to the input data from the specific user acquired from at least part of the user interface and at least one sensor interworking with the user terminal 300.

Specifically, the avatars may help the specific user access the virtual-reality based educational-training system 200. Further, the avatars may provide not only information on components and functions but also individual feedbacks by analyzing the input data from the specific user acquired by the user terminal 300, while providing the respective contents to the specific user.

Also, the avatars may be characters modeled after humans, so that it can provide exemplary actions and responses for the respective contents to the specific user. Through the avatars, the specific user may be able to train various contents properly. For example, in training automobile maintenance, the avatars may provide valuable information such as proper relative positions between an automobile and the specific user while repairing the automobile.

Further, the avatars may provide information on the incorrect actions and incorrect responses from the specific user or other users. For example, the avatars may pop up messages and may provide an alarm to make the specific user to concentrate thereon, before the specific user trains the basic motion data or the practice motion data including the incorrect actions.

Furthermore, the avatars may manage a training progress of the specific user and may provide messages of encouragement. For example, in a case that the specific user and other users are in a same group, if an achievement rate of the specific user is lower than that of said other users, or if a success rate of the specific user while training the basic motion or the practice motion is lower than that of said other users, the avatars may pop up the messages of encouragement or provide an alarm to make the specific user to concentrate thereon.

In accordance with the present disclosure, there is an effect of providing methods for adjustable evaluation, which are different from the conventional evaluations, by analyzing the training state of the multiple users.

The embodiments of the present disclosure as explained above can be implemented in a form of executable program command through a variety of computer means recordable to computer readable media. The computer readable media may include solely or in combination, program commands, data files, and data structures. The program commands recorded to the media may be components specially designed for the present disclosure or may be usable to a skilled artisan in a pertinent field. Computer readable record media include magnetic media such as hard disk, floppy disk, and magnetic tape, optical media such as CD-ROM and DVD, magneto-optical media such as floptical disk and hardware devices such as ROM, RAM, and flash memory specially designed to store and carry out programs. Program commands include not only a machine language codes made by a complier but also a high level codes that can be used by an interpreter etc., which is executed by a computing device. The aforementioned hardware device can work as more than a software module to perform the technical features of the present disclosure and they can do the same in the opposite case.

As seen above, the present disclosure has been specifically described by such matters as detailed components, limited embodiments, and drawings. While the disclosure has been shown and described with respect to the preferred embodiments, it, however, may be appreciated by those skilled in the art that various changes and modifications may be made without departing from the spirit and the scope of the present disclosure as defined in the following claims.

Accordingly, the thought of the present disclosure must not be confined to the explained preferred or example embodiments, and the following patent claims as well as everything including variations equal or equivalent to the patent claims pertain to the category of the thought of the present disclosure.

What is claimed is:

1. A method for adjusting a training of a specific user, comprising steps of:
(a) a server acquiring identification information of the specific user from a user terminal, and
(b) the server performing or supporting another device to perform, by referring to the identification information, at least one of (I) a first process of allowing the specific user to train at least part of basic knowledge data and basic motion data on a specific subject by providing at least one pre-training content to the user terminal; (II) a second process of allowing the specific user to train at least part of one or more practice knowledge data or practice motion data on the specific subject by providing at least one practice training content to the user terminal; and (III) a third process of allowing the specific user to train at least part of one or more application knowledge data and application motion data required to solve one or more scenario-based problems on the specific subject by providing at least one scenario-based training content to the user terminal.

2. The method of claim 1, wherein, at the first process, the server performs or supports another device to perform processes of:
(I-1) creating the pre-training content by referring to at least part of (i) (1_1)-st data including first incorrect motion data, as the basic motion data of multiple users, generated in response to multiple first contents on the specific subject; and (ii) (1_2)-nd data including second incorrect motion data, as the basic motion data of the specific user, generated in response to the multiple first contents on the specific subject; and
(I-2) providing the created pre-training content to the user terminal.

3. The method of claim 2, wherein the server performs or supports another device to perform processes of: (i) creating the pre-training content by applying weights determined by the specific user or the server respectively to the (1_1)-st data and the (1_2)-nd data, and (ii) providing the created pre-training content to the user terminal.

4. The method of claim 1, wherein, at the first process, the server performs or supports another device to perform processes of:
(I-1) extracting a specific basic motion data, corresponding to multiple first contents on the specific subject, from (i) (2_1)-st data including third incorrect motion data, as the basic motion data of multiple users, generated in response to multiple second contents on another subject; and (ii) (2_2)-nd data including forth incorrect motion data, as the basic motion data of the specific user, generated in response to the multiple second contents on said subject;
(I-2) creating the pre-training content by referring to at least part of the extracted specific basic motion data, and
(I-3) providing the created pre-training content to the user terminal.

5. The method of claim 4, wherein the server performs or supports another device to perform processes of: (i) creating the pre-training content by applying weights determined by the specific user or the server respectively to the (2_1)-st data and the (2_2)-nd data, and (ii) providing the created pre-training content to the user terminal.

6. The method of claim 1, wherein, at the second process, the server performs or supports another device to perform processes of:
(II-1) setting at least part of a minimum allotted time and the number of repetitions for k-th practice motion data respectively corresponding to multiple k-th practice training contents,
(II-2) if the specific user attains the minimum allotted time corresponding to the k-th practice motion data while training a specific k-th practice training content, (i) in case one or more times are left for the specific user to reach the number of repetitions for specific k-th practice motion data, allowing the specific user to train a specific k-th practice motion by performing at least part of (i-1) decreasing the minimum allotted time assigned to the specific k-th practice training content for the specific user; and (i-2) decreasing the number of repetitions assigned to the specific k-th practice training content for the specific user; and (ii) in case the specific user reaches the number of repetitions, allowing the specific user to complete the specific k-th practice motion, and
(II-3) if the specific user fails to attain the minimum allotted time corresponding to the k-th practice motion data while training the specific k-th practice training content, allowing the specific user to train the specific k-th practice motion by performing at least part of (i) increasing the minimum allotted time assigned to the specific k-th practice training content for the specific user; and (ii) increasing the number of repetitions assigned to the specific k-th practice training content for the specific user.

7. The method of claim 1, wherein the server performs or supports another device to perform processes of:
(I) providing (i) one or more diagnosis evaluations to estimate the specific user's achievement in the pre-training content; (ii) one or more formative evaluations, containing one or more progress evaluations, practice evaluations and test evaluations, to estimate the specific user's achievement in the practice training content; and (iii) one or more summative evaluations to estimate the specific user's achievement in the scenario-based training content; to the user terminal,
(II) adjusting (i) allotted scores for respective actions included in the practice evaluations by referring to respective practice evaluation data acquired from multiple user terminals respectively corresponding to multiple users; and (ii) allotted scores for respective items included in the test evaluations by referring to respective test evaluation data acquired from the multiple user terminals respectively corresponding to multiple users, and
(III) adjusting a ratio of the allotted scores for the respective progress evaluations, practice evaluations and test evaluations included in the respective formative evaluations by referring to an adjusted total score of the practice evaluations and to an adjusted total score of the formative evaluations, wherein the adjusted total score of the practice evaluations is acquired by adjusting the allotted scores for the respective actions included in the practice evaluations by referring to the respective practice evaluation data acquired from the multiple user terminals respectively corresponding to the multiple users, and wherein the adjusted total score of the test evaluations is acquired by adjusting the allotted scores for the respective items included in the test evaluations by referring to the respective test evaluation data acquired from the multiple user terminals respectively corresponding to multiple users.

8. The method of claim 1, wherein, on condition that at least part of progress evaluations, practice evaluations, and test evaluations is provided in order to estimate the specific user's achievement respectively in the pre-training content, the practice training content, and the scenario-based training content, to the user terminal, wherein a total score of the respective practice evaluations is determined by referring to individual scores for respective multiple actions included in the respective practice evaluations, and wherein initial allotted scores and modifiable ranges of the individual allotted scores respectively corresponding to the multiple actions are predetermined, the server performs or supports another device to perform processes of:
(I) acquiring incorrect action data respectively from multiple user terminals of respective multiple users created in response to the multiple practice evaluations respectively corresponding to the pre-training content, the practice training content, and the scenario-based training content, in order to adjust the individual allotted scores for the respective multiple actions included in the respective practice evaluations;
(II) if the number of a specific incorrect action of the multiple users is same as or larger than the predetermined threshold, an allotted score for the specific incorrect action increases; and
(III) if the number of the specific incorrect action of the multiple users is less than the predetermined threshold, the allotted score for the specific action decreases.

9. The method of claim 1, wherein, on condition that at least part of progress evaluations, practice evaluations, and test evaluations is provided in order to estimate the specific user's achievement respectively in the pre-training content, the practice training content, and the scenario-based training content, to the user terminal, wherein a total score of the respective test evaluations is determined by referring to individual scores for respective multiple items included in the respective test evaluations, and wherein initial allotted scores and modifiable ranges of individual allotted scores respectively corresponding to the multiple items are predetermined, the server performs or supports another device to perform processes of:
(I) acquiring incorrect response rate data from respective multiple user terminals of respective multiple users created in response to the multiple test evaluations respectively corresponding to the pre-training content, the practice training content, and the scenario-based training content, in order to adjust the individual allotted scores for the respective multiple items included in the respective test evaluations;
(II) if an incorrect response rate of a specific item from the multiple users is same as or larger than the predetermined threshold, an allotted score for the specific item increases; and
(III) if the incorrect response rate of the specific item from the multiple users is less than the predetermined threshold, the allotted score for the specific item decreases.

10. The method of claim 1, wherein the server provides one or more avatars to guide the specific user, wherein, by referring to input data on the specific user acquired from at least part of interfaces and sensors interworking with the user terminal, the avatar performs at least part of processes of (I) providing the respective contents to the specific user, (II) showing at least part of exemplary actions and responses for the respective contents to the specific user, (III) providing information on incorrect actions and incorrect responses from the specific user or other users, and (IV) managing training progress of the specific user and providing messages of encouragement.

11. A server for adjusting a training of a specific user, comprising:
at least one memory that stores instructions; and
at least one processor configured to execute the instructions to: perform or support another device to perform, by referring to identification information of the specific user from a user terminal, at least one of (I) a first process of allowing the specific user to train at least part of basic knowledge data and basic motion data on a specific subject by providing at least one pre-training content to the user terminal; (II) a second process of allowing the specific user to train at least part of one or more practice knowledge data or practice motion data on the specific subject by providing at least one practice training content to the user terminal; and (III) a third process of allowing the specific user to train at least part of one or more application knowledge data and application motion data required to solve one or more scenario-based problems on the specific subject by providing at least one scenario-based training content to the user terminal.

12. The server of claim 11, wherein, at the first process, the processor performs or supports another device to perform processes of:
(I-1) creating the pre-training content by referring to at least part of (i) (1_1)-st data including incorrect motion data, as the basic motion data of multiple users, generated in response to multiple first contents on the specific subject; and (ii) (1_2)-nd data including incorrect motion data, as the basic motion data of the specific user, generated in response to multiple first contents on the specific subject; and
(I-2) providing the created pre-training content to the user terminal.

13. The server of claim 12, wherein the processor performs or supports another device to perform processes of: (i) creating the pre-training content by applying weights determined by the specific user or the processor respectively to the (1_1)-st data and the (1_2)-nd data, and (ii) providing the created pre-training content to the user terminal.

14. The server of claim 11, wherein, at the first process, the processor performs or supports another device to perform processes of:
(I-1) extracting a specific basic motion data, corresponding to multiple first contents on the specific subject, from (i) (2_1)-st data including incorrect motion data, as the basic motion data of multiple users, generated in response to multiple second contents on another subject; and (ii) (2_2)-nd data including incorrect motion data, as the basic motion data of the specific user, generated in response to the multiple second contents on said subject;
(I-2) creating the pre-training content by referring to at least part of the extracted specific basic motion data, and
(I-3) providing the created pre-training content to the user terminal.

15. The server of claim 14, the processor performs or supports another device to perform processes of: (i) creating the pre-training content by applying weights determined by the specific user or the processor respectively to the (2_1)-st data and the (2_2)-nd data, and (ii) providing the created pre-training content to the user terminal.

16. The server of claim 11, wherein, at the second process, the processor performs or supports another device to perform processes of:
(II-1) setting at least part of a minimum allotted time and the number of repetitions for k-th practice motion data respectively corresponding to multiple k-th practice training contents,
(II-2) if the specific user attains the minimum allotted time corresponding to the k-th practice motion data while training a specific k-th practice training content, (i) in case one or more times are left for the specific user to reach the number of repetitions for specific k-th practice motion data, allowing the specific user to train a specific k-th practice motion by performing at least part of (i-1) decreasing the minimum allotted time assigned to the specific k-th practice training content for the specific user; and (i-2) decreasing the number of repetitions assigned to the specific k-th practice training content for the specific user; and (ii) in case the specific user reaches the number of repetitions, allowing the specific user to complete the specific k-th practice motion, and
(II-3) if the specific user fails to attain the minimum allotted time corresponding to the k-th practice motion data while training the specific k-th practice training content, allowing the specific user to train the specific k-th practice motion by performing at least part of (i) increasing the minimum allotted time assigned to the specific k-th practice training content for the specific user; and (ii) increasing the number of repetitions assigned to the specific k-th practice training content for the specific user.

17. The server of claim 11, wherein the processor performs or supports another device to perform processes of:
(I) providing (i) one or more diagnosis evaluations to estimate the specific user's achievement in the pre-training content; (ii) one or more formative evaluations, containing one or more progress evaluations, practice evaluations and test evaluations, to estimate the specific user's achievement in the practice training content; and (iii) one or more summative evaluations to estimate the specific user's achievement in the scenario-based training content; to the user terminal,
(II) adjusting (i) allotted scores for respective actions included in the practice evaluations by referring to respective practice evaluation data acquired from multiple user terminals respectively corresponding to multiple users; and (ii) those for respective items included in the test evaluations by referring to respective test evaluation data acquired from the multiple user terminals respectively corresponding to multiple users, and
(III) adjusting a ratio of the allotted scores for the respective progress evaluations, practice evaluations and test evaluations included in the respective formative evaluations by referring to an adjusted total score of the practice evaluations and to an adjusted total score of the formative evaluations, wherein the adjusted total score of the practice evaluations are acquired by adjusting the allotted scores for the respective actions included in the practice evaluations by referring to the respective practice evaluation data acquired from the multiple user terminals respectively corresponding to the multiple users, and wherein the adjusted total score of the formative evaluations is acquired by adjusting the allotted scores for the respective items included in the test evaluations by referring to the respective test evaluation data acquired from the multiple user terminals respectively corresponding to multiple users.

18. The server of claim 11, wherein, on condition that at least part of progress evaluations, practice evaluations, and test evaluations is provided in order to estimate the specific user's achievement respectively in the pre-training content, the practice training content, and the scenario-based training content, to the user terminal, wherein a total score of the respective practice evaluations is determined by referring to individual scores for respective multiple actions included in the respective practice evaluations, and wherein initial allotted scores and modifiable ranges of the individual allotted scores respectively corresponding to the multiple actions are predetermined, the processor performs or supports another device to perform processes of:
(I) acquiring incorrect action data respectively from multiple user terminals of respective multiple users created in response to the multiple practice evaluations respectively corresponding to the pre-training content, the practice training content, and the scenario-based training content, in order to adjust the individual allotted scores for the respective multiple actions included in the respective practice evaluations;
(II) if the number of a specific incorrect action of the multiple users is same as or larger than the predetermined threshold, an allotted score for the specific incorrect action increases; and
(III) if the number of the specific incorrect action of the multiple users is less than the predetermined threshold, the allotted score for the specific action decreases.

19. The server of claim 11, wherein, on condition that at least part of progress evaluations, practice evaluations, and test evaluations is provided in order to estimate the specific user's achievement respectively in the pre-training content, the practice training content, and the scenario-based training content, to the user terminal, wherein a total score of the respective test evaluations is determined by referring to individual scores for respective multiple items included in the respective test evaluations, and wherein initial allotted scores and modifiable ranges of individual allotted scores respectively corresponding to the multiple items are predetermined, the processor performs or supports another device to perform processes of:
(I) acquiring incorrect response rate data from respective multiple user terminals of respective multiple users created in response to the multiple test evaluations respectively corresponding to the pre-training content, the practice training content, and the scenario-based training content, in order to adjust the individual allotted scores for the respective multiple items included in the respective test evaluations;
(II) if an incorrect response rate of a specific item from the multiple users is same as or larger than the predetermined threshold, an allotted score for the specific item increases; and
(III) if the incorrect response rate of the specific item from the multiple users is less than the predetermined threshold, the allotted score for the specific item decreases.

20. The server of claim 11, wherein the processor provides one or more avatars to guide the specific user, wherein, by referring to input data on the specific user acquired from at least part of interfaces and sensors interworking with the user terminal, the avatar performs at least part of processes of (I) providing the respective contents to the specific user, (II) showing at least part of exemplary actions and responses for the respective contents to the specific user, (III) providing information on incorrect actions and incorrect responses from the specific user or other users, and (IV) managing training progress of the specific user and providing messages of encouragement.
